(19) United States
(12) Patent Application Publication
(10) Pub. No.: US 2009/0311508 A1
(43) Pub. Date: Dec. 17, 2009

(54) LAYERED THERMAL BARRIER COATING WITH A HIGH POROSITY, AND A COMPONENT

(76) Inventor: Werner Stamm, Mulheim an der Ruhr (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/225,932

(22) PCT Filed: Jan. 22, 2007
(86) PCT No.: PCT/EP2007/050620

§ 371 Date: Oct. 1, 2008

(30) Foreign Application Priority Data
May 6, 2006 (EP) PCT/EP2006/061370

(51) Int. Cl. B32B 18/00

(52) U.S. Cl. 428/316.6

(57) ABSTRACT

Layered thermal barrier coating with high porosity. Ceramic thermal barrier coatings according to the state of the art often do not withstand the thermal and mechanical stresses. The inventive ceramic thermal barrier coating comprises two ceramic thermal barrier layers with a different porosity, in which even the inner ceramic thermal barrier layer has a high porosity

### CROSS REFERENCE TO RELATED APPLICATIONS

This application is the US National Stage of International Application No. PCT/EP2007/050620, filed Jan. 22, 2007 and claims the benefit thereof. The International Application claims the benefits of International application No. PCT/EP2006/061370 filed Apr. 6, 2006, both of the applications are incorporated by reference herein in their entirety.

### FIELD OF INVENTION

The invention relates to a layered thermal barrier coating with a high porosity and to a component according to the claims.

### BACKGROUND OF THE INVENTION

U.S. Pat. No. 4,299,865 discloses a two layered ceramic thermal barrier coating with an outer layer which has a very high porosity between 20 vol % and 33 vol % and a dense inner ceramic thermal barrier layer.

Patent EP 0 816 526 B1 discloses a thermal barrier coating system with only a single layer which has a porosity between 20 vol % and 35 vol %.

U.S. Pat. No. 4,936,745 discloses a single ceramic layer which has a porosity between 20 vol % and 35 vol %.

US 2004/0126599 A1 discloses a two layered thermal barrier coating with different micro structures.

The thermal barrier coatings are substantially functional layers and are intended to protect the substrate, for example from excessive heat. The substrate has a sufficiently high mechanical strength. The thermal barrier coatings are likewise exposed to thermal stresses and/or mechanical stresses and may fail as a result of cracks.

### SUMMARY OF INVENTION

Therefore, it is an object of the invention to provide a thermal barrier coating and a component in which the layers are better able to withstand thermal and mechanical stresses.

This object is achieved by a thermal barrier coating and by a component.

### BRIEF DESCRIPTION OF THE DRAWINGS

Exemplary embodiments are shown in the figures.

FIG. 1 shows one example of a thermal barrier coating,

FIG. 2 shows another example of a thermal barrier coating,

FIG. 3 lists some superalloys of substrates for the thermal barrier coating,

FIG. 4 shows a gas turbine,

FIG. 5 shows a turbine blade or vane and

FIG. 6 shows a combustion chamber.

### DETAILED DESCRIPTION OF INVENTION

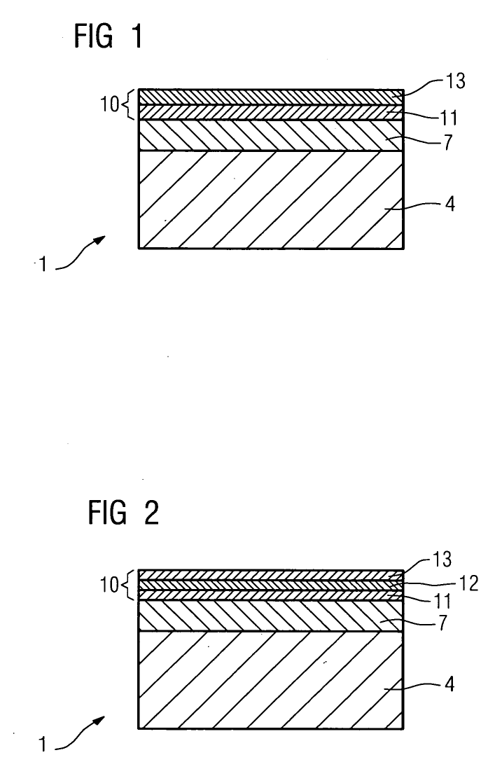

In FIG. 1 one example of a thermal barrier coating system 1 is shown.

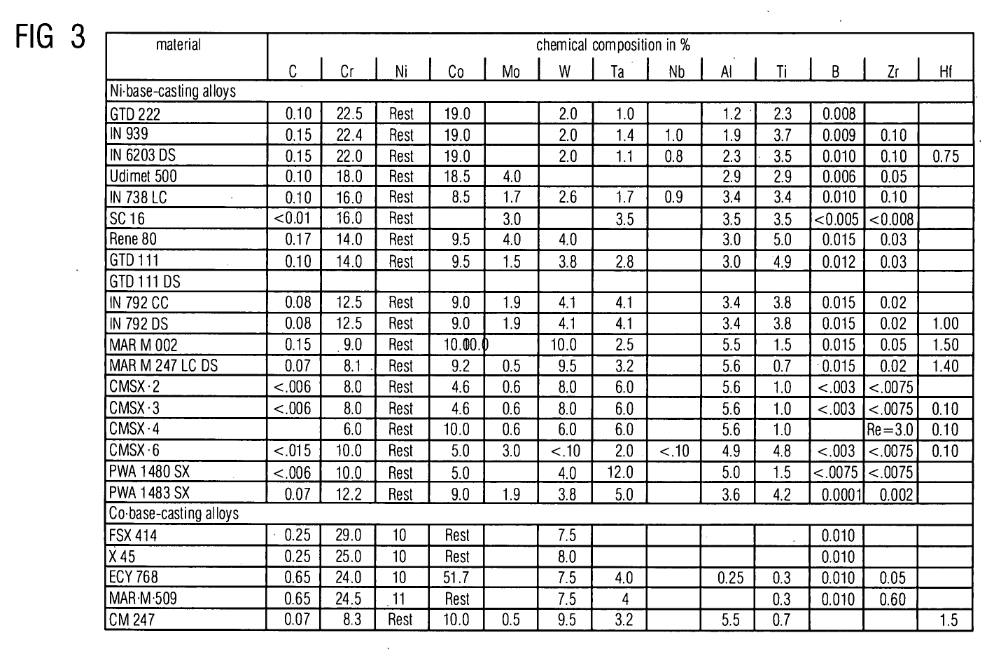

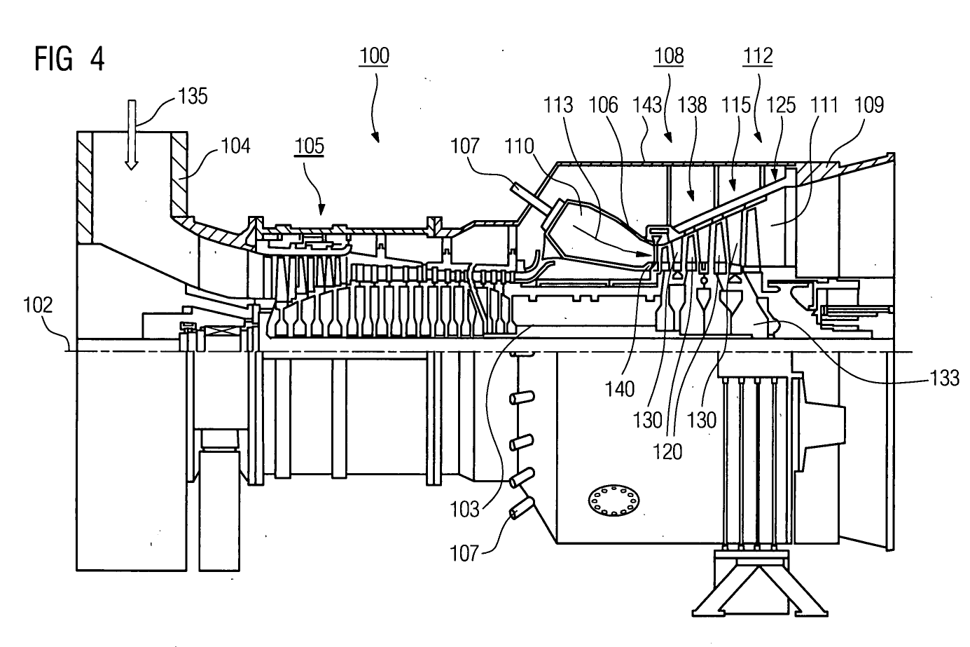

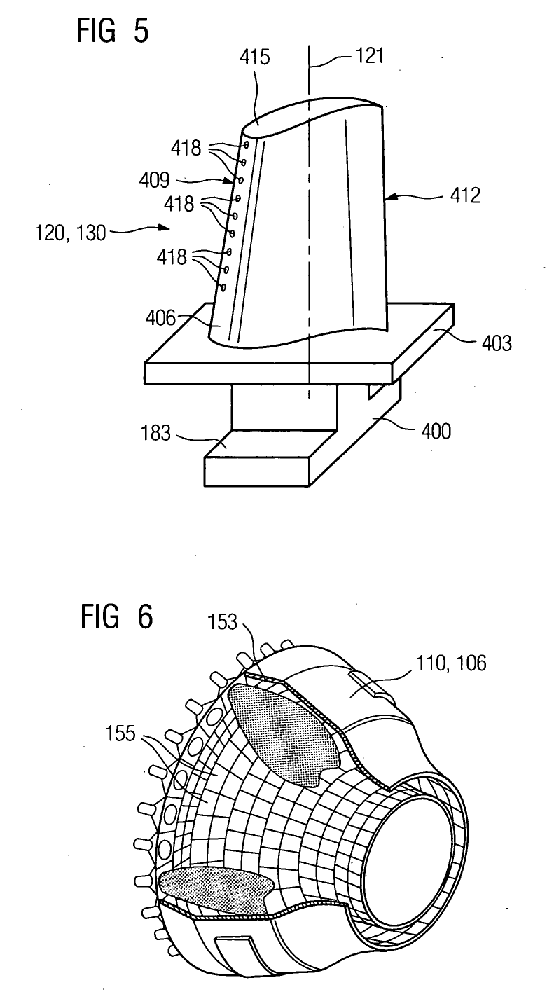

The thermal barrier coating system 1 comprises a metallic substrate 4, which is cobalt or nickel based and is a component 120, 130 (FIG. 5), 155 (FIG. 6) for a gas turbine 100 (FIG. 4). It is made of a superalloy (FIG. 3).

A metallic bonding layer 7 of the MCrAlX type is preferably applied to this substrate 4. A thermally grown oxide layer (TGO) (not shown) is formed on this metallic bonding layer 7 during operation or before applying further coatings (10).

An at least two layered ceramic thermal barrier coating 10 is applied to the metallic bonding layer 7. The ceramic thermal barrier coating 10 has an inner ceramic thermal barrier layer 11 and an outer ceramic thermal barrier layer 13, which faces a hot medium, especially the hot gas path of a gas turbine 100.

The outer ceramic layer 13 has a higher porosity than the inner ceramic layer 11.

The ranges of the porosity of the inner 11 and the outer 13 ceramic layers do not overlap and do not have same values.

One advantageous example is: the inner ceramic thermal barrier layer 11 has a porosity between 5 vol % and 11 vol % especially between 9 vol % and 11 vol % and the outer ceramic thermal barrier layer 13 has a porosity between 20 vol % and 27 vol %, especially between 13 vol % and 27 vol %. It is clearly apparent that the maximum value of the porosity of the inner ceramic thermal barrier layer 11 is much lower than the minimum value of the porosity of the outer ceramic thermal barrier layer 13.

In FIG. 2 another example of the advantageous thermal barrier coating 10 is shown.

An intermediate ceramic thermal barrier layer 12 is present between the inner ceramic thermal barrier layer 11 and the outer ceramic thermal barrier layer 13, which faces a hot medium, especially the hot gas path of a gas turbine 100. One advantageous example is: the inner ceramic thermal barrier layer 11 has a porosity between 5 vol % and 11 vol %, especially between 9 vol % and 11 vol % and the outer ceramic thermal barrier layer 13 has a porosity between 20 vol % and 27 vol %, especially between 13 vol % and 27 vol %.

The porosity of the intermediate ceramic thermal barrier layer 12 is lower than the porosity of the outer ceramic thermal barrier layer 13. In particular, the porosity of the intermediate ceramic thermal barrier layer 12 fits between the ranges of the inner 11 and the outer 13 ceramic thermal barrier layers. More advantageously, the porosity of this layer 12 changes gradually between the value of the porosity of the inner ceramic thermal barrier layer 11 and the value of the outer ceramic thermal barrier layer 13.

The intermediate ceramic thermal barrier coating 12 has advantageous values for the layer thickness of up to 150 μm, especially up to 75 μm.

In particular the inner ceramic thermal barrier layer 11 of the examples in FIGS. 1, 2 has a thickness of 100 μm to 150 μm, especially 125 μm.

The outer ceramic thermal barrier coating 13 of the examples in FIGS. 1, 2 has a thickness between 150 μm and 2 mm, especially between 1 mm and 2 mm.

The material for the ceramic coating 11, 12, 13 can be selected as desired, and in particular yttria-stabilized-zirconia (Y₂O₃—ZrO₂) is used.

Even different materials for the coatings 11, 12, 13 can be used.

FIG. 4 shows, by way of example, a partial longitudinal section through a gas turbine 100.

In the interior, the gas turbine 100 has a rotor 103 which is mounted such that it can rotate about an axis of rotation 102, has a shaft 101 and is also referred to as the turbine rotor.

An intake housing 104, a compressor 105, a, for example, toroidal combustion chamber 110, in particular an annular combustion chamber, with a plurality of coaxially arranged burners 107, a turbine 108 and the exhaust-gas housing 109 follow one another along the rotor 103.

The annular combustion chamber 110 is in communication with a, for example, annular hot-gas passage 111, where, by way of example, four successive turbine stages 112 form the turbine 108.

Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133.

A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield bricks which line the annular combustion chamber 110, are subject to the highest thermal stresses.

To be able to withstand the temperatures which prevail there, they can be cooled by means of a coolant.

Substrates of the components may likewise have a directional structure, i.e. they are in single-crystal form (SX structure) or have only longitudinally oriented grains (DS structure).

By way of example, iron-based, nickel-based or cobalt-based superalloys are used as material for the components, in particular for the turbine blade or vane 120, 130 and components of the combustion chamber 110.

Superalloys of this type are known, for example, from EP 1 204 776 B1, EP 1 306 454, EP 1 319 729 A1, WO 99/67435 or WO 00/44949; these documents form part of the disclosure with regard to the chemical composition of the alloys.

The guide vane 130 has a guide vane root (not shown here) facing the inner housing 138 of the turbine 108 and a guide vane head at the opposite end from the guide vane root. The guide vane head faces the rotor 103 and is fixed to a securing ring 140 of the stator 143.

FIG. 5 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 as well as a blade or vane tip 415.

As a guide vane 130, the vane 130 may have a further platform (not shown) at its vane tip 415.

A blade or vane root 183, which is used to secure the rotor blades 120, 130 to a shaft or disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949; these documents form part of the disclosure with regard to the chemical composition of the alloy.

The blade or vane 120, 130 may in this case be produced by a casting process, also by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1; these documents form part of the disclosure with regard to the solidification process.

The blades or vanes 120, 130 may likewise have coatings protecting against corrosion or oxidation, e.g. MCrAlX (M is at least one element selected from the group consisting of iron (Fe), cobalt (Co), nickel (Ni), X is an active element and represents yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1, which are intended to form part of the present disclosure with regard to the chemical composition of the alloy.

The density is preferably 95% of the theoretical density.

A protective aluminum oxide layer (TGO=thermally grown oxide layer) forms on the MCrAlX layer (as an intermediate layer or an outermost layer).

It is also possible for a thermal barrier coating, consisting for example of ZrO₂, Y₂O₃—ZrO₂, i.e. unstabilized, partially stabilized or fully stabilized by yttrium oxide and/or calcium oxide and/or magnesium oxide, which is preferably the outermost layer, to be present on the MCrAlX.

The thermal barrier coating covers the entire MCrAlX layer. Columnar grains are produced in the thermal barrier coating by means of suitable coating processes, such as for example electron beam physical vapor deposition (EB-PVD).

Other coating processes are conceivable, for example atmospheric plasma spraying (APS), LPPS, VPS or CVD. The thermal barrier coating may include porous grains which have microcracks or macrocracks for improving its resistance to thermal shocks. The thermal barrier coating is therefore preferably more porous than the MCrAlX layer.

The blade or vane 120, 130 may be hollow or solid in form. If the blade or vane 120, 130 is to be cooled, it is hollow and may also have film-cooling holes 418 (indicated by dashed lines).

FIG. 6 shows a combustion chamber 110 of the gas turbine 100. The combustion chamber 110 is configured, for example, as what is known as an annular combustion chamber, in which a multiplicity of burners 107 arranged circumferentially around an axis of rotation 102 open out into a common combustion chamber space 154 and generate flames 156. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155.

A cooling system may also be provided for the heat shield elements 155 and/or their holding elements, on account of the high temperatures in the interior of the combustion chamber 110. The heat shield elements 155 are then, for example, hollow and if appropriate also have cooling holes (not shown) opening out into the combustion chamber space 154.

Each heat shield element 155 made from an alloy is provided on the working medium side with a particularly heat-resistant protective layer (MCrAlX layer and/or ceramic coating) or is made from high-temperature-resistant material (solid ceramic bricks).

These protective layers may be similar to those used for the turbine blades or vanes, i.e. for example meaning MCrAlX: M is at least one element selected from the group consisting of iron (Fe), cobalt (Co), nickel (Ni), X is an active element and represents yttrium (Y) and/or silicon and/or at least one rare earth element, or hafnium (Hf). Alloys of this type are known from EP 0 486 489 B1, EP 0 786 017 B1, EP 0 412 397 B1 or EP 1 306 454 A1, which are intended to form part of the present disclosure with regard to the chemical composition of the alloy.

It is also possible for a, for example, ceramic thermal barrier coating, consisting for example of ZrO₂, Y₂O₃—ZrO₂, i.e. unstabilized, partially stabilized or fully stabilized by yttrium oxide and/or calcium oxide and/or magnesium oxide, to be present on the MCrAlX.

Columnar grains are produced in the thermal barrier coating by means of suitable coating processes, such as for example electron beam physical vapor deposition (EB-PVD).

Other coating processes are conceivable, for example atmospheric plasma spraying (APS), LPPS, VPS or CVD. The thermal barrier coating may have porous grains which have microcracks or macrocracks to improve its resistance to thermal shocks.

Refurbishment means that after they have been used, protective layers may have to be removed from turbine blades or vanes 120, 130, heat shield elements 155 (e.g. by sand-blasting). Then, the corrosion and/or oxidation layers and products are removed. If appropriate, cracks in the turbine blade or vane 120, 130 or the heat shield element 155 are also repaired. This is followed by recoating of the turbine blades or vanes 120, 130, heat shield elements 155, after which the turbine blades or vanes 120, 130 or the heat shield elements 155 can be reused.

1.-17. (canceled)

18. A thermal barrier coating for a component, having at least two layers, comprising:
an inner ceramic thermal barrier layer arranged closest to a substrate of the component and having a porosity between 9 vol % and 11 vol %; and
an outer ceramic thermal barrier layer arranged furthest from the substrate and having a porosity between 23 vol % and 27 vol %.

19. The thermal barrier coating according to claim 18, wherein an intermediate ceramic thermal barrier layer is arranged between the inner and the outer ceramic thermal barrier layer.

20. The thermal barrier coating according to claim 19, wherein the porosity of the intermediate ceramic thermal barrier layer changes gradually from a minimum to a maximum value.

21. The thermal barrier coating according to claim 20, wherein the porosity of the intermediate ceramic thermal barrier layer is between the maximum value of the inner ceramic layer and the minimum value of the outer ceramic layer.

22. The thermal barrier coating according to claim 21, wherein the porosity of the intermediate ceramic thermal barrier layer increases from the inner layer to the outer layer, from 23 vol % to 27 vol %.

23. The thermal barrier coating according to claim 21, wherein the porosity of the intermediate ceramic thermal barrier layer has a constant value between 23 vol % to 27 vol %.

24. The thermal barrier coating according to claim 23, wherein the layer thickness of the inner ceramic thermal barrier layer is between 100 μm and 150 μm.

25. The thermal barrier coating according to claim 24, wherein the layer thickness of the intermediate ceramic thermal barrier layer is up to 150 μm.

26. The thermal barrier coating according to claim 25, wherein the layer thickness of the ceramic outer barrier layer is between 1 mm and 2 mm.

27. Thermal barrier coating according to claim 26, wherein the ceramic thermal barrier layers are made of yttria-stabilized-zirconia.

28. A component having a thermal barrier coating, comprising:
a substrate;
an inner ceramic thermal barrier layer arranged closest to the substrate of the component, the inner ceramic thermal barrier layer having a porosity between 9 vol % and 11 vol %; and
an outer ceramic thermal barrier layer arranged furthest from the substrate, the outer ceramic thermal barrier layer having a porosity between 23 vol % and 27 vol %.

29. The component according to claim 28, further comprising an intermediate metallic layer arranged on the substrate wherein the metallic layer composition (in wt %) is selected from the group consisting of:
12% Co, 21% Cr, 11% Al, 0.4% Y, 2% Re and balance Ni;
25% Co, 17% Cr, 10% Al, 0.5% Y, 1.5% Re and balance Ni; and
30% Ni, 28% Cr, 8% Al, 0.6% Y, 0.7% Si and balance Co.

30. The component according to claim 29, wherein the substrate is nickel based.

31. The component according to claim 30, wherein the substrate is cobalt based.

32. The component according to claim 31, wherein the component is a turbine blade, a turbine vane, a turbine heat shield or a turbine casing.
